(19) United States
(12) Patent Application Publication
(10) Pub. No.: US 2026/0308482 A1
(43) Pub. Date: Oct. 8, 2026

(54) CARBONATE INHIBITING COMPOSITION

(71) Applicant: NOURYON CHEMICALS INTERNATIONAL B.V., Amsterdam (NL)

(72) Inventors: Klin Aloysius RODRIGUES, Signal Mountain, TN (US); Matthew Michael VANDERHOOF, Chattanooga, TN (US)

(73) Assignee: NOURYON CHEMICALS INTERNATIONAL B.V., Amsterdam (NL)

(21) Appl. No.: 19/462,090

(22) Filed: Jan. 28, 2026

Related U.S. Application Data
(60) Provisional application No. 63/751,041, filed on Jan. 29, 2025.

(51) Int. Cl. C11D 3/20; C11D 1/72; C11D 3/04; C11D 3/10; C11D 3/33; C11D 3/36; C11D 3/386; C11D 3/395

(52) U.S. Cl. CPC C11D 3/2082; C11D 1/72; C11D 3/046; C11D 3/10; C11D 3/33; C11D 3/361; C11D 3/38618; C11D 3/3951; C11D 3/3956

(57) ABSTRACT

A composition includes:
an adjunct ingredient chosen from a surfactant, a builder, a corrosion inhibitor, a chelating agent, and combinations thereof; and
a carbonate inhibiting oligomer component comprising a compound (I) having the structure:

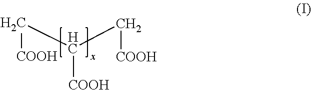

wherein x is independently about 1 and/or 3.

### CROSS-REFERENCE TO RELATED APPLICATIONS

This application claims the benefit of U.S. Provisional Application No. 63/751,041 filed on Jan. 29, 2025, which is hereby expressly incorporated herein by reference in its entirety.

### TECHNICAL FIELD

The present disclosure generally relates to a carbonate inhibiting composition that includes an adjunct ingredient and a carbonate inhibiting oligomer component. More specifically, this disclosure relates to a carbonate inhibiting composition that includes an adjunct ingredient chosen from a surfactant, a builder, a corrosion inhibitor, a chelating agent, and combinations thereof along with the oligomer component.

### BACKGROUND

Many aqueous systems require various materials to remain in a soluble, suspended or dispersed state. Examples of such aqueous systems include boiler water or steam generating systems, cooling water systems, gas scrubbing systems, pulp and paper mill systems, desalination systems, fabric, dishware and hard surface cleaning systems, as well as downhole systems encountered during the production of gas, oil, and geothermal wells. Often the water in those systems either naturally or by contamination contains ingredients such as inorganic salts. These salts can cause accumulation, deposition, and fouling problems in aqueous systems such as those mentioned above.

Inorganic salts are typically formed by the reaction of metal cations (e.g., calcium, magnesium or barium) with inorganic anions (e.g., phosphate, carbonate or sulfate). When formed, the salts tend to be insoluble or have low solubility in water. As their concentration in solution increases or as the pH and/or temperature of the solution containing those salts changes, the salts can precipitate from solution, crystallize and form hard deposits or scale on surfaces. Such scale formation is a problem in equipment such as heat transfer devices, boilers, secondary oil recovery wells, laundry machines and automatic dishwashers, as well as on substrates washed with such hard waters, reducing the performance and life of such equipment.

Stabilization of aqueous systems that include scale-forming salts and inorganic particulates involves a variety of mechanisms. Inhibition is one conventional mechanism for eliminating the deleterious effect of scale-forming salts. In inhibition, compounds are added that increase the solubility of the scale-forming salt in the aqueous system.

Another stabilization mechanism is the dispersion of precipitated salt crystals that function as good dispersants for precipitated salts such as calcium carbonates. In this mechanism, the crystals stay dispersed rather than dissolving in the aqueous solution.

A third stabilization mechanism involves interference and distortion of the crystal structure of the scale by various compounds, thereby making the scale less adherent to surfaces, other forming crystals and/or existing particulates.

Cleaning formulations include builders such as phosphates and carbonates for boosting their cleaning performance. These builders can precipitate insoluble salts such as calcium carbonate and calcium phosphate in the form of calcium orthophosphate. The precipitants form deposits on clothes and dishware that results in unsightly films and spots on these articles.

Various attempts have been made to control scale. However, there remains opportunity for improvement. Furthermore, other desirable features and characteristics of the present disclosure will become apparent from the subsequent detailed description of the disclosure and the appended claims, taken in conjunction with this background of the disclosure.

### BRIEF SUMMARY

This disclosure provides a composition comprising:
an adjunct ingredient chosen from a surfactant, a builder, a corrosion inhibitor, a chelating agent, and combinations thereof; and
a carbonate inhibiting oligomer component comprising a compound (I) having the structure:

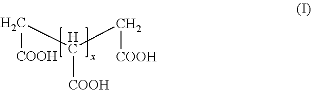

wherein x is independently about 1 and/or 3.

### DETAILED DESCRIPTION

The following detailed description is merely exemplary in nature and is not intended to limit the current composition. Furthermore, there is no intention to be bound by any theory presented in the preceding background or the following detailed description.

Embodiments of the present disclosure are generally directed to oligomers, compositions including the same, and methods for forming the same. For the sake of brevity, conventional techniques related to making oligomers and such compositions may not be described in detail herein. Moreover, the various tasks and process steps described herein may be incorporated into a more comprehensive procedure or process having additional steps or functionality not described in detail herein. In particular, various steps in the manufacture of oligomers and associated compositions are well-known and so, in the interest of brevity, many conventional steps will only be described briefly herein or will be omitted entirely without providing the well-known process details.

In this disclosure, the terminology “about” can describe values ±0.1, 0.5, 1, 2, 3, 4, 5, 6, 7, 8, 9, 10, 15, or 20%, in various embodiments. Moreover, it is contemplated that, in various non-limiting embodiments, it is to be appreciated that all numerical values as provided herein, save for the actual examples, are approximate values with endpoints or particular values intended to be read as “about” or “approximately” the value as recited. It is also contemplated that all isomers and chiral options for each compound described herein are hereby expressly contemplated for use herein in various non-limiting embodiments.

Throughout this disclosure, the terminology percent “actives” is well recognized in the art and means the percent amount of active or actual compound or molecule present as compared to, for example, a total weight of a diluted solution of a solvent and such a compound. Some compounds, such as a solvent, are not described relative to a percent actives because it is well known to be approximately 100% actives. Any one or more of the values described herein may be alternatively described as percent actives as would be understood by the skilled person.

In various embodiments, the terminology “free of” describes embodiments that include less than about 5, 4, 3, 2, 1, 0.5, or 0.1, weight percent (or weight percent actives) of the compound or element at issue using an appropriate weight basis as would be understood by one of skill in the art. In other embodiments, the terminology “free of” describes embodiments that have zero weight percent of the compound or element at issue.

The terminology “consists essentially of” may describe various non-limiting embodiments that are free of one or more optional compounds described herein and/or free of one or more polymers, surfactants, additives, solvents, etc.

It is to be understood that the subscripts of oligomers and polymers are typically described as average values because the synthesis of oligomers and polymers typically produces a distribution of various individual molecules.

The oligomers and compositions disclosed herein may suitably comprise, consist of, or consist essentially of the components, elements, and process delineations described herein. The embodiments illustratively disclosed herein suitably may be practiced in the absence of any element which is not specifically disclosed herein.

### Composition

This disclosure provides a carbonate inhibiting composition (hereinafter “composition”) that includes an adjunct ingredient and a carbonate inhibiting oligomer component. The terminology “carbonate inhibiting oligomer component” and “oligomer” can be used interchangeably herein. In various embodiments, the composition is, includes, consists essentially of, or consists of, the adjunct ingredient and the carbonate inhibiting oligomer component. The terminology “consists essentially of” describes various embodiments that are free of, or include less than about 5, 4, 3, 2, 1, 0.5, or 0.1, weight percent of one or more of monomers and/or oligomers or polymers different from the carbonate inhibiting oligomer component, adjunct ingredients different from surfactants, builders, corrosion inhibitors, and chelating agents, or compounds such as solvents, additives, etc. which may be described herein or otherwise known in the art.

The composition is not particularly limited and may be any known in the art. In various embodiments, the composition is a cleaning formulation, such as a laundry detergent or a hard or soft surface cleaning composition, or an automatic dishwasher detergent. In other embodiments, the composition is used in water treatment systems. In a further embodiment, the composition is used in oilfield applications.

The composition may be a liquid, solid, paste, or gel. The skilled person will choose depending on the application. The composition may be described as a non-phosphate composition, as is known in the art, e.g. as defined by the EPA. Such a composition may include less than about 0.5, 0.4, 0.3, 0.2, 0.1, 0.05, or 0.01, weight percent actives of phosphate, or may be entirely free of phosphates, based on a total weight of the composition. In various non-limiting embodiments, all values, both whole and fractional, between and including all of the above, are hereby expressly contemplated for use herein.

### Adjunct Ingredient

The adjunct ingredient is chosen from a surfactant, a builder, a corrosion inhibitor, a chelating agent, and combinations thereof. In one embodiment, the adjunct ingredient is a surfactant. In another embodiment, the adjunct ingredient is a builder. In a further embodiment, the adjunct ingredient is a corrosion inhibitor. In a further embodiment, the adjunct ingredient is a chelating agent. The weight percent (or percent actives) of the adjunct ingredient is not particularly limited and may be chosen by the skilled person.

### Surfactant

If the adjunct ingredient is a surfactant, then any surfactant can be used. For example, the surfactant may be anionic, cationic, nonionic, amphoteric, or zwitterionic. A single surfactant or two or more surfactants may be used.

For example, in various embodiments wherein the composition is an automatic dishwashing composition, the amount of surfactant typically is from about 0.1 to about 15, about 0.5 to about 10, about 1 to about 10, about 1 to about 5, or about 5 to about 10, weight percent actives, based on a total weight of the composition. In some embodiments, a nonionic surfactant is used and is present in an amount of from about 1 to about 5 weight percent actives based on a total weight of the composition, e.g. to help reduce surface tension and help with soil removal, especially greasy residues. In other embodiments, an anionic surfactant is used and is present in an amount of from about 0.5 to about 2 weight percent actives based on a total weight of the composition. In further embodiments, an amphoteric surfactant is utilized and is present in an amount of from about 0.5 to about 2 weight percent actives based on a total weight of the composition. In various non-limiting embodiments, all values, both whole and fractional, between and including all of the above, are hereby expressly contemplated for use herein.

In other embodiments wherein the composition is a detergent or laundry composition, the amount of surfactant may depend on whether the composition is a liquid, solid, paste, or gel. For example, in powder detergents, the amount of surfactant may be from about 5 to about 25, about 10 to about 20, or about 10 to about 15, weight percent actives based on a total weight of the composition. In other embodiments, such as in liquid detergents, the surfactant may be present in an amount of from about 15 to about 50, about 20 to about 45, about 25 to about 40, or about 30 to about 35, weight percent actives based on a total weight of the composition. In further embodiments, e.g. in high efficiency detergents, the amount of surfactant may be from about 5 to about 25, about 10 to about 20, or about 10 to about 15, weight percent actives based on a total weight of the composition. In even further embodiments, e.g. laundry pods/single use packs, the amount of surfactant may be from about 5 to about 70, about 10 to about 65, about 15 to about 60, about 20 to about 55, about 25 to about 50, about 30 to about 45, about 40 to about 60, weight percent actives based on a total weight of the composition. Anionic surfactants are typically used in such composition as primary cleaning agents and are typically utilized in amount of from about 10 to about 20 weight percent actives based on a total weight of the composition. Nonionic surfactants are typically used in such compositions for grease removal and emulsification in an amount of from about 5 to about 15 weight percent actives based on a total weight of the composition. Amphoteric and/or cationic surfactants are typically used for fabric softening or other specialized used and are present in an amount of from about 1 to about 5 weight percent actives based on a total weight of the composition. In various non-limiting embodiments, all values, both whole and fractional, between and including all of the above, are hereby expressly contemplated for use herein.

In various embodiments, the surfactant is or includes an anionic surfactant. For example, such a surfactant may be chosen from sodium lauryl sulfate, sodium laureth sulfate, linear alkylbenzene sulfonates (LAS), alpha-olefin sulfonates (AOS), sodium stearate, sodium dodecylbenzenesulfonate, sodium cocoyl isethionate, sodium methyl cocoyl taurate, sulfosuccinates, sodium myreth sulfate, alkyl ether sulfates, sodium xylenesulfonate, sodium octane sulfonate, sodium undecylenate, sodium caprylate, sodium cetyl sulfate, sodium alkyl sulfates, sodium sulfonated fatty acids, and combinations thereof.

In various embodiments, the surfactant is or includes a cationic surfactant. For example, such a surfactant may be chosen from cetyltrimethylammonium bromide (CTAB), benzalkonium chloride, benzethonium chloride, cetrimonium chloride, stearyltrimethylammonium chloride, lauryl dimethyl benzyl ammonium chloride, quaternary ammonium compounds (quats), dioctyldimethylammonium chloride, dodecyltrimethylammonium bromide, cetylpyridinium chloride, myristyltrimethylammonium bromide, alkylbenzyldimethylammonium chloride, laurylpyridinium chloride, and combinations thereof.

In various embodiments, the surfactant is or includes a nonionic surfactant. For example, such a surfactant may be chosen from alkyl polyglucosides (APGs), Ethoxylated alcohols, Polysorbates (e.g., Polysorbate 20, Polysorbate 80), nonylphenol ethoxylates, octylphenol ethoxylates, cocamide MEA, cocamide DEA, fatty alcohol ethoxylates, sorbitan monostearate, sorbitan tristearate, lauryl alcohol ethoxylates, stearyl alcohol ethoxylates, decyl glucoside, capryl glucoside, polyethylene glycol (peg) esters, lauryl glucoside, myristyl glucoside, and combinations thereof.

In various embodiments, the surfactant is or includes a zwitterionic surfactant. For example, such a surfactant may be chosen from cocamidopropyl betaine, lauramidopropyl betaine, sodium cocoamphoacetate, lauryl hydroxysultaine, coco betaine, cocamidopropyl hydroxysultaine, amphoacetates, amphopropionates, dimethylaminopropionate, lauryl sulfobetaine.

In various embodiments, the surfactant is or includes an amphoteric surfactant. For example, such a surfactant may be chosen from cocamidopropylamine oxide, lauramine oxide, myristamine oxide, cocamine oxide, dodecylamine oxide, alkyl amine oxides, amphoacetates, amphodiacetates, n-alkyl beta-amino propionates, lauryl dihydroxyethyl betaine, and combinations thereof.

In various embodiments, the surfactant is or includes a linear alkylbenzene sulfonate (LAS) such as dodecylbenzenesulfonic acid. The LAS may have a linear alkyl chain that has, e.g. 10 to 13 carbon atoms. These carbon atoms are present in approximately the following mole ratios C10:C11:C12:C13 is about 13:30:33:24 having an average carbon number of about 11.6 and a content of the most hydrophobic 2-phenyl isomers of about 18-29 wt %. The linear alkylbenzene sulfonate may be any known in the art. In various non-limiting embodiments, all values, both whole and fractional, between and including all of the above, are hereby expressly contemplated for use herein.

In other embodiments, the surfactant is or includes an alkoxylated alcohol. The alkoxylated alcohol may be a C₈-C₂₀ alcohol that is capped with (or includes) approximately 2 to 12 moles of an alkylene oxide. In other embodiments, the alkoxylated alcohol may be an alcohol alkoxylate that has from 8 to 20, 10 to 18, 12 to 16, or 12 to 14, carbon atoms and is an ethoxylate, propoxylate, or butoxylate and is capped with an alkylene oxide, e.g. ethylene oxide, propylene oxide, or butylene oxide. The alkoxylated alcohol may be capped with varying numbers of moles of the alkylene oxide, e.g. about 2 to about 12, about 3 to about 11, about 4 to about 10, about 5 to about 9, about 6 to about 8, or about 7 to about 8, moles. In various non-limiting embodiments, all values, both whole and fractional, between and including all of the above, are hereby expressly contemplated for use herein.

In various embodiments, the surfactant is or includes an alcohol ethoxy sulfate (AES) and/or monoethanolamine. In further embodiments, the surfactant may include soaps which contain sulfate or sulfonate groups, including those with alkali metal ions as cations, can be used. Usable soaps include alkali metal salts of saturated or unsaturated fatty acids with 12 to 18 carbon (C) atoms. Such fatty acids may also be used in incompletely neutralized form. Usable ionic surfactants of the sulfate type include the salts of sulfuric acid semi esters of fatty alcohols with 12 to 18 C atoms. Usable ionic surfactants of the sulfonate type include alkane sulfonates with 12 to 18 C atoms and olefin sulfonates with 12 to 18 C atoms, such as those that arise from the reaction of corresponding mono-olefins with sulfur trioxide, alpha-sulfofatty acid esters such as those that arise from the sulfonation of fatty acid methyl or ethyl esters. Other suitable additional surfactants include alkyl glycosides and ethoxylation and/or propoxylation products of alkyl glycosides or linear or branched alcohols in each case having 12 to 18 carbon atoms in the alkyl moiety and 3 to 20, or 4 to 10, alkyl ether groups. Corresponding ethoxylation and/or propoxylation products of N-alkylamines, vicinal diols, and fatty acid amides, which correspond to the alkyl moiety in the stated long-chain alcohol derivatives, may furthermore be used. Alkylphenols having 5 to 12 carbon atoms may also be used in the alkyl moiety of the above described long-chain alcohol derivatives. Even further, the surfactant may be chosen from alkoxylates, polyglycerols, glycol ethers, glycols, polyethylene glycols, polypropylene glycols, polybutylene glycols, glycerol ester ethoxylates, polysorbates, alkyl ether sulfates, alkyl- and/or arylsulfonates, alkyl sulfates, ester sulfonates (sulfo-fatty acid esters), ligninsulfonates, fatty acid cyanamides, anionic sulfosuccinic acid surfactants, fatty acid isethionates, acylaminoalkane-sulfonates (fatty acid taurides), fatty acid sarcosinates, ether carboxylic acids and alkyl(ether)phosphates. In such embodiments, suitable nonionic surfactants include C₂-C₆-alkylene glycols and poly-C₂-C₃-alkylene glycol ethers, optionally, etherified on one side with a C₁-C₆-alkanol and having, on average, 1 to 9 identical or different, typically identical, alkylene glycol groups per molecule, and also alcohols and fatty alcohol polyglycol ethers, typically propylene glycol, dipropylene glycol, trimethylolpropane, and fatty alcohols with low degrees of ethoxylation having 6 to 22, typically 8 to 18, more typically 8 to 12, and even more typically 8 to 11, carbon atoms. Moreover, suitable ionic surfactants include alkyl ether sulfates, sulfosuccinic acid surfactants, polyacrylates and phosphonic acids, typically lauryl sulfate, lauryl ether sulfate, sodium sulfosuccinic acid diisooctyl ester, 1-hydroxyethane-1,1-diphosphonic acid, and diacetyltartaric esters.

### Builder

A single builder or two or more builders may also be used. As is known in the art, the role of a builder in a cleaning composition is to enhance the cleaning efficiency by softening water (e.g. by chelating calcium and magnesium ions), maintaining alkalinity, suspending soils, and minimizing re-deposition of dirt. The builder is not particularly limited and may be any known in the art. For example, the builder may be chosen from sodium tripolyphosphate, sodium carbonate, sodium citrate, zeolites, polyacrylic acid, sodium silicate, sodium metasilicate, potassium carbonate, potassium citrate, sodium percarbonate, sodium borate, sodium oxalate, sodium phytate, potassium pyrophosphate, sodium pyrophosphate, sodium polyaspartate, sodium aluminate, sodium bicarbonate, potassium bicarbonate, magnesium silicate, sodium polymethacrylate, maleic acid copolymers, sodium sesquicarbonate, sodium tartrate, potassium tartrate, sodium sulfate, magnesium sulfate.

If used, the builder is typically present in the composition in an amount of from about 1 to about 60, about 1 to about 55, about 1 to about 50, about 5 to about 45, about 10 to about 40, about 15 to about 35, about 20 to about 30, or about 25 to about 30, weight percent, based on a total weight of the composition. In one embodiment, wherein the composition is a powdered household detergent, the builder is typically present in an amount of from about 10 to about 50 weight percent, based on a total weight of the composition. In another embodiment, wherein the composition is a liquid household detergent, the builder is typically present in an amount of from about 5 to about 20 weight percent, based on a total weight of the composition. In another embodiment, wherein the composition is an industrial or institutional cleaning product, the builder is typically present in an amount of from about 10 to about 60 weight percent, based on a total weight of the composition. In another embodiment, wherein the composition is a heavy duty cleaning agent, the builder is typically present in an amount of from about 20 to about 50 weight percent, based on a total weight of the composition. In another embodiment, wherein the composition is a dishwashing detergent, the builder is typically present in an amount of from about 5 to about 40 weight percent, based on a total weight of the composition. In various non-limiting embodiments, all values and ranges of values, both whole and fractional, between and including the values described above, are hereby expressly contemplated for use herein.

### Corrosion Inhibitors

In other embodiments, the adjunct ingredient may be a corrosion inhibitor. A single corrosion inhibitor or two or more corrosion inhibitors may be used. The corrosion inhibitor is not particularly limited and may be any known in the art. In various embodiments, the corrosion inhibitor is chosen from azoles, phosphates, orthophosphate, phosphonates, silicates, molybdates, amines and others. Phosphonates include 2-phosphonobutane-1,2,4-tricarboxylic acid (PBTC) or 1-hydroxyethylidene(1,1-diphosphonic acid) (IEDP) and others. One skilled in the art will recognize that phosphonate and other ingredients may perform multiple functions in addition to corrosion inhibition including scale control. If used, the corrosion inhibitor is typically present in the composition in an amount of from about 1 to about 60, about 1 to about 55, about 1 to about 50, about 5 to about 45, about 10 to about 40, about 15 to about 35, about 20 to about 30, or about 25 to about 30, weight percent, based on a total weight of the composition. In various non-limiting embodiments, all values and ranges of values, both whole and fractional, between and including the values described above, are hereby expressly contemplated for use herein.

### Chelating Agent

In other embodiments, the adjunct ingredient may be the chelating agent. A single chelating agent or two or more chelating agents may be used. The chelating agent is not particularly limited and may be any known in the art. In various embodiments, the chelating agent is chosen from ethylenediaminetetraacetic acid (EDTA), tetrasodium EDTA, disodium EDTA, nitrilotriacetic acid (NTA), diethylenetriaminepentaacetic acid (DTPA), ethylenediamine-N,N′-disuccinic acid (EDDS), sodium gluconate, aminopolycarboxylates, methylglycine diacetic acid (MGDA), sodium iminodisuccinate (IDS), glutamic acid diacetic acid (GLDA), and combinations thereof.

Various compositions, e.g. automatic dishwashing compositions, may incorporate a variety of chelating agents to improve cleaning performance by sequestering metal ions and minimizing scale buildup on dishes and machine surfaces. These chelating agents can include any described herein, e.g. sodium citrate, typically present in amounts of from 5 to 20, about 10 to 15, or about 5 to 15 weight percent actives, based on a total weight of the composition. Phosphonates, such as hydroxyethylidene diphosphonic acid (HEDP) or aminotris(methylenephosphonic acid) (ATMP), may be included in amounts of from about 0.5 to 5, about 1 to about 4, or about 2 to about 3, weight percent actives based on a total weight of the composition. Emerging biodegradable chelants, such as methylglycinediacetic acid (MGDA) and glutamic acid diacetate (GLDA), are increasingly favored in environmentally conscious formulations, with usage levels of from about 5 to about 15, about 5 to about 10, or about 10 to about 15, weight percent actives based on a total weight of the composition. EDTA (ethylenediaminetetraacetic acid) or its salts may also be used, generally in amounts of from about 0.5 to about 3 weight percent actives based on a total weight of the composition. Additional chelants such as polycarboxylates may complement these agents, typically at concentrations of from about 0.1 to about 5 weight percent actives based on a total weight of the composition. In various non-limiting embodiments, all values and ranges of values, both whole and fractional, between and including the values described above, are hereby expressly contemplated for use herein.

Other compositions, e.g. laundry detergent compositions, utilize chelating agents to enhance cleaning efficiency by reducing water hardness, improving surfactant performance, and preventing redeposition of soil onto fabrics. Sodium citrate is a common eco-friendly choice, which may be used in an amount of from about 1 to about 10 weight percent actives based on a total weight of the composition. Zeolites, widely used in powder formulations, are typically incorporated in amounts of from about 5 to about 25 weight percent actives based on a total weight of the composition. Phosphonates, such as HEDP and ATMP, may also be present in amounts of from about 0.5 to about 3 weight percent actives based on a total weight of the composition. Biodegradable options like MGDA and GLDA are increasingly popular, with concentrations of from about 1 to about 8 weight percent actives based on a total weight of the composition. Polycarboxylates are another versatile option, which can be incorporated in amounts of from about 2 to about 8 weight percent actives based on a total weight of the composition. In various non-limiting embodiments, all values and ranges of values, both whole and fractional, between and including the values described above, are hereby expressly contemplated for use herein.

In one embodiment, the surfactant is present and is chosen from dodecylbenzene sulfonic acid, an alkoxylated alcohol, and combinations thereof. In one embodiment, the builder is present and is sodium carbonate. In one embodiment, the chelating agent is present and is chosen from glutamic acid N,N-diacetic acid, methylglycinediacetic acid, and combinations thereof.

It is contemplated that the composition may include one of the options for the adjunct ingredient and none of the others. Alternatively, two or more of the adjunct ingredients may be used. All combinations of the aforementioned adjunct ingredients are hereby expressly contemplated for use herein in various non-limiting embodiments.

### Carbonate Inhibiting Oligomer Component

Referring back, the composition also includes the carbonate inhibiting oligomer component. This component includes a compound (I) described below. The component may include, or be free of, a compound (II) also described below. The component may be, include, consist essentially of, or consist of, compound (I) with or without compound (II). In various embodiments, the terminology “consist essentially of” describes that the composition is free of, or includes less than about 0.5, 0.4, 0.3, 0.2, 0.1, 0.05, or 0.01, weight or mole percent of one or more oligomers, polymer, additives, etc. that are not compound (I) and/or compound (II). The component may include a single version of compound (I) but typically includes multiple different molecules of compound (I) because oligomers are typically formed as distributions of molecules. Similarly, the component may include a single version of compound (II) but typically includes multiple different molecules of compound (II) because oligomers are typically formed as distributions of molecules. In other words, mixtures of molecules of compound (I) and/or compound (II) may be used. In various non-limiting embodiments, all values and ranges of values, both whole and fractional, between and including the values described above, are hereby expressly contemplated for use herein.

Compound (I) of the oligomer component has the following structure:

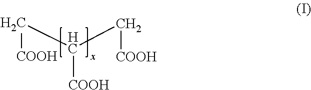

wherein x is independently about 1 and/or 3. For example, the oligomer component may include, or be free of, versions of compound (I) wherein x is from about 0.5 to about 1.5, about 0.6 to about 1.4, about 0.7 to about 1.3, about 0.8 to about 1.2, about 0.9 to about 1.1, about 0.95 to about 1.05, etc. Similarly, the oligomer component may include, or be free of, versions of compound (I) wherein x is from about 2.6 to about 3.5, about 2.7 to about 3.4, about 2.8 to about 3.3, about 2.9 to about 3.2, about 2.9 to about 3.1, about 2.95 to about 3.05, etc. In various embodiments, the oligomer component includes versions of compound (I) wherein x is about 1 and is free of, or includes less than 5, 4, 3, 2, or 1, weight or mole percent, of versions of compound (I) wherein x is about 3. Similarly, in other embodiments, the oligomer component includes versions of compound (I) wherein x is about 3 and is free of, or includes less than 5, 4, 3, 2, or 1, weight or mole percent, of versions of compound (I) wherein x is about 1. In various non-limiting embodiments, all values and ranges of values, both whole and fractional, between and including the values described above, are hereby expressly contemplated for use herein.

It is contemplated that the composition and the oligomer component may include, or be free of, compound (II) having the structure:

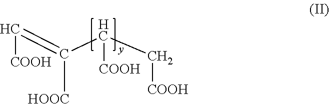

wherein y is independently about 1 and/or 3. For example, the oligomer component may include, or be free of, versions of compound (II) wherein y is from about 0.5 to about 1.5, about 0.6 to about 1.4, about 0.7 to about 1.3, about 0.8 to about 1.2, about 0.9 to about 1.1, about 0.95 to about 1.05, etc. Similarly, the oligomer component may include, or be free of, versions of compound (II) wherein y is from about 2.6 to about 3.5, about 2.7 to about 3.4, about 2.8 to about 3.3, about 2.9 to about 3.2, about 2.9 to about 3.1, about 2.95 to about 3.05, etc. In various embodiments, the oligomer component includes versions of compound (II) wherein y is about 1 and is free of, or includes less than 5, 4, 3, 2, or 1, weight or mole percent, of versions of compound (II) wherein y is about 3. Similarly, in other embodiments, the oligomer component includes versions of compound (II) wherein y is about 3 and is free of, or includes less than 5, 4, 3, 2, or 1, weight or mole percent, of versions of compound (II) wherein y is about 1. In various non-limiting embodiments, all values and ranges of values, both whole and fractional, between and including the values described above, are hereby expressly contemplated for use herein.

In one embodiment, the oligomer component includes a first compound (I) wherein x is about 1 and a second compound (I) wherein x is about 3, or any range described above. In another embodiment, the oligomer component includes a first compound (II) wherein y is about 1 and a second compound (II) wherein y is about 3, or any range described above. In still other embodiments, the oligomer component includes a first compound (I) wherein x is about 1, a second compound (I) wherein x is about 3, a first compound (II) wherein x is about 1, and a second compound (II) wherein x is about 3, or any range described above. In various non-limiting embodiments, all values and ranges of values, both whole and fractional, between and including the values described above, are hereby expressly contemplated for use herein.

In a further embodiment, the oligomer component includes about 20 to about 30, about 21 to about 29, about 22 to about 28, about 23 to about 27, about 24 to about 26, or about 25, mole percent of compound (I) wherein x is about 1; and about 20 to about 30, about 21 to about 29, about 22 to about 28, about 23 to about 27, about 24 to about 26, or about 25, mole percent of compound (I) wherein x is about 3. In various non-limiting embodiments, all values and ranges of values, both whole and fractional, between and including the values described above, are hereby expressly contemplated for use herein.

In other embodiments, the oligomer component includes about 10 to about 90 mole percent of a first compound (I) wherein x is about 1; and about 10 to about 90 mole percent of a second compound (I) wherein x is about 3. In other embodiments, the oligomer component includes about 10 to about 90 mole percent of a first compound (II) wherein y is about 1; and about 10 to about 90 mole percent of a second compound (II) wherein y is about 3. In various embodiments, the oligomer component includes about 10 to about 90, about 15 to about 85, about 20 to about 80, about 25 to about 75, about 30 to about 70, about 35 to about 65, about 40 to about 60, about 45 to about 55, or about 50, mole percent of a first compound (I) wherein x is about 1. In other embodiments, the oligomer component includes about 10 to about 90, about 15 to about 85, about 20 to about 80, about 25 to about 75, about 30 to about 70, about 35 to about 65, about 40 to about 60, about 45 to about 55, or about 50, mole percent of a first compound (I) wherein x is about 3. In further embodiments, the oligomer component includes about 10 to about 90, about 15 to about 85, about 20 to about 80, about 25 to about 75, about 30 to about 70, about 35 to about 65, about 40 to about 60, about 45 to about 55, or about 50, mole percent of a first compound (II) wherein y is about 1. In further embodiments, the oligomer component includes about 10 to about 90, about 15 to about 85, about 20 to about 80, about 25 to about 75, about 30 to about 70, about 35 to about 65, about 40 to about 60, about 45 to about 55, or about 50, mole percent of a second compound (II) wherein y is about 3. In various non-limiting embodiments, all values and ranges of values, both whole and fractional, between and including the values described above, are hereby expressly contemplated for use herein.

In still other embodiments, the oligomer component comprises: about 5 to about 25 mole percent of a first compound (II) wherein y is about 1; and about 5 to about 25 mole percent of a second compound (II) wherein y is about 3. In some embodiments, the amount of the first compound (II) wherein y is about 1 is about 10 to about 20, about 10 to about 15, or about 15 to about 20, mole %. In other embodiments, the amount of the first compound (II) wherein y is about 3 is about 10 to about 20, about 10 to about 15, or about 15 to about 20, mole %. In various non-limiting embodiments, all values and ranges of values, both whole and fractional, between and including the values described above, are hereby expressly contemplated for use herein.

Compound (I) or (II) Wherein x and/or y is about 2

Typically, the composition and the oligomer component are free of, or include less than 25, 20, 15, 10, 9, 8, 7, 6, 5, 4, 3, 2, or 1, weight or mole percent of a compound (I) and/or a compound (II) wherein x is about 2 and/or y is about 2, respectively, based on a total weight of compound (I). In some embodiments, the composition and/or oligomer component are entirely free of a compound (I) and/or a compound (II) wherein x is about 2 and/or y is about 2, respectively. In various non-limiting embodiments, all values and ranges of values, both whole and fractional, between and including the values described above, are hereby expressly contemplated for use herein.

As shown in the Examples, it was surprisingly discovered that use of a compound (I) and/or (II) wherein x and/or y is each about “2” does not work nearly as well as the inventive composition. Therefore, versions of compounds (I) and (II) wherein each of x and y are about 2 are preferably avoided or minimized. Typically, compounds are typically avoided or minimized wherein each of x and y are independently from about 1.6 to about 2.4, about 1.7 to about 2.3, about 1.8 to about 2.2, about 1.9 to about 2.1, or about 2. In various non-limiting embodiments, all values and ranges of values, both whole and fractional, between and including the values described above, are hereby expressly contemplated for use herein.

In various embodiments, the inventors found that it was very surprising that “x” equal to about 2 has very poor performance whereas “x” being a mixture of about one and/or about three (with a minimal amount of x of about two) has excellent performance.

In various embodiments, the oligomer component is, includes, consists essentially or, or consists of:
about 35 to about 45 mole percent of compound (I) wherein x is about 1;
about 1 to about 10 mole percent of compound (I) wherein x is about 2;
about 50 to about 60 mole percent of compound (I) wherein x is about 3;
about 1 to about 10 mole percent of compound (II) wherein y is about 1;
about 0 to about 10 mole percent of compound (II) wherein y is about 2; and
about 1 to about 10 mole percent of compound (II) wherein y is about 3.
   In various non-limiting embodiments, all values and ranges of values, both whole and fractional, between and including the values described above, are hereby expressly contemplated for use herein.

In various embodiments, the oligomer component is, includes, consists essentially or, or consists of:
about 35 to about 40 mole percent of compound (I) wherein x is about 1;
about 6 to about 8 mole percent of compound (I) wherein x is about 2;
about 50 to about 55 mole percent of compound (I) wherein x is about 3;
about 6 to about 12 mole percent of compound (II) wherein y is about 1;
about 6 to about 12 mole percent of compound (II) wherein y is about 2; and
about 6 to about 12 mole percent of compound (II) wherein y is about 3.
   In various non-limiting embodiments, all values and ranges of values, both whole and fractional, between and including the values described above, are hereby expressly contemplated for use herein.

In other embodiments, the oligomer component is, includes, consists essentially or, or consists of:
about 40 to about 45 mole percent of compound (I) wherein x is about 1;
about 1 to about 5 mole percent of compound (I) wherein x is about 2;
about 55 to about 60 mole percent of compound (I) wherein x is about 3;
about 1 to about 2 mole percent of compound (II) wherein y is about 1;
about 0 to about 1 mole percent of compound (II) wherein y is about 2; and
about 0 to about 1 mole percent of compound (II) wherein y is about 3.
   In various non-limiting embodiments, all values and ranges of values, both whole and fractional, between and including the values described above, are hereby expressly contemplated for use herein.

Referring back to the oligomer component as a whole, the oligomer component is not particularly limited in terms of weight percent in the overall composition. In various embodiments, the oligomer component is present in an amount of from about 0.1 to about 50 weight percent actives based on a total weight of the composition. In various embodiments, this amount is from 0.5 to 45, 1.0 to 44.5, 1.5 to 44, 2.0 to 43.5, 2.5 to 43, 3.0 to 42.5, 3.5 to 42, 4.0 to 41.5, 4.5 to 41, 5.0 to 40.5, 5.5 to 40, 6.0 to 39.5, 6.5 to 39, 7.0 to 38.5, 7.5 to 38, 8.0 to 37.5, 8.5 to 37, 9.0 to 36.5, 9.5 to 36, 10.0 to 35.5, 10.5 to 35, 11.0 to 34.5, 11.5 to 34, 12.0 to 33.5, 12.5 to 33, 13.0 to 32.5, 13.5 to 32, 14.0 to 31.5, 14.5 to 31, 15.0 to 30.5, 15.5 to 30, 16.0 to 29.5, 16.5 to 29, 17.0 to 28.5, 17.5 to 28, 18.0 to 27.5, 18.5 to 27, 19.0 to 26.5, 19.5 to 26, 20.0 to 25.5, 20.5 to 25, 21.0 to 24.5, 21.5 to 24, 22.0 to 23.5, or 22.5 to 23, weight percent actives based on a total weight of the composition. In various non-limiting embodiments, all values and ranges of values, both whole and fractional, between and including the values described above, are hereby expressly contemplated for use herein.

In other embodiments, the oligomer component is present in an amount of from about 0.25 to about 25 weight percent actives based on a total weight of the composition. In various embodiments, the amount is from 0.5 to 25, 1.0 to 24.5, 1.5 to 24, 2.0 to 23.5, 2.5 to 23, 3.0 to 22.5, 3.5 to 22, 4.0 to 21.5, 4.5 to 21, 5.0 to 20.5, 5.5 to 20, 6.0 to 19.5, 6.5 to 19, 7.0 to 18.5, 7.5 to 18, 8.0 to 17.5, 8.5 to 17, 9.0 to 16.5, 9.5 to 16, 10.0 to 15.5, 10.5 to 15, 11.0 to 14.5, 11.5 to 14, 12.0 to 13.5, or 12.5 to 13, weight percent actives based on a total weight of the composition. In various non-limiting embodiments, all values and ranges of values, both whole and fractional, between and including the values described above, are hereby expressly contemplated for use herein.

In further embodiments, the oligomer component is present in an amount of from about 0.5 to about 5 weight percent actives based on a total weight of the composition. In various embodiments, the amount is from 0.5 to 5, 1.0 to 4.5, 1.5 to 4, 2.0 to 3.5, or 2.5 to 3, weight percent actives based on a total weight of the composition. In various non-limiting embodiments, all values and ranges of values, both whole and fractional, between and including the values described above, are hereby expressly contemplated for use herein.

In additional embodiments, the oligomer component is present in an amount of from about 1 to about 3 weight percent actives based on a total weight of the composition. In various embodiments, the amount is from about 1.5 to about 2.5 or from about 1.5 to about 2, weight percent actives based on a total weight of the composition. In various non-limiting embodiments, all values and ranges of values, both whole and fractional, between and including the values described above, are hereby expressly contemplated for use herein.

In still other embodiments, the oligomer component is present in an amount of from about 1 to about 5 weight percent actives based on a total weight of the composition. In various embodiments, the amount is from about 1.5 to about 4.5, about 2 to about 4, about 2.5 to about 3.5, or about 3 to about 3.5, weight percent actives based on a total weight of the composition. In various non-limiting embodiments, all values and ranges of values, both whole and fractional, between and including the values described above, are hereby expressly contemplated for use herein.

### Water

The composition may also include water or be free of water. In various embodiments, water may be present in an amount from 0 to about 99.99 weight percent, based on a total weight of the composition. In other embodiments, this amount is from 5 to 95, 10 to 90, 15 to 85, 20 to 80, 25 to 75, 30 to 70, 35 to 65, 40 to 60, 45 to 55, or about 50, weight percent based on a total weight of the composition. The amount of water may refer to a total amount of water present in the composition from all components, i.e., not simply water added independently from any particular component. In various non-limiting embodiments, all values, both whole and fractional, between and including all of the above, are hereby expressly contemplated for use herein.

An independent source of water, such as DI water, may be used to dilute the composition. This water may be independent from any water present in the composition as originating from one or more components. In other words, the composition includes water originating from the components themselves. However, to further dilute the composition, the independent water source may be used.

### Additives

The composition may include, or be free of, one or more additives. Such additives can include, but are not limited to, those described below.

In various embodiments, the additive may be chosen from bleaching agents such as peroxygen compounds, chlorine-releasing agents, bleach precursors, bleach activators such as tetraacetylethylenediamine (TAED), nonanoyloxybenzene sulfonate (NOBS), enzymes such as proteases, amylases, lipases, cellulases, mannanases, anti-redeposition agents such as carboxymethylcellulose (CMC), polyvinyl alcohols, soil-release polymers, anti-redeposition polymers, thickening agents, antifoaming agents, silicone-based compounds, fatty alcohols, fragrances and perfumes, synthetic fragrances, essential oils, dyes and optical brighteners, fluorescent whitening agents, fabric-safe dyes, preservatives, formaldehyde donors, isothiazolinones, dispersants, polycarboxylates, acrylate/maleate copolymers, stabilizers, pH adjusters, buffers sodium hydroxide, fillers, anti-scaling agents, polyacrylate dispersants, disinfectants and antimicrobial agents, quaternary ammonium compounds, triclosan, conditioners, fabric softening agents, anti-wrinkle polymers, opacifiers, water treatment chemicals, dyes, fillers, fabric whiteners, brighteners, sudsing control agents, additional functional additives, oxygen scavengers, hydrotropes, solvents.

In various embodiments, the additive may be chosen from phosphates, metal carbonate, citrates, enzymes, bleach systems, buffers, perfumes, anti-foam agents, ion exchangers, alkalis, anti-redeposition materials, optical brighteners, fragrances, dyes, fillers, fabric whiteners, brighteners, sudsing control agents, solvents, hydrotropes, bleaching agents, bleach precursors, buffering agents, soil removal agents, soil release agents, fabric softening agents, opacifiers, water treatment chemicals, corrosion inhibitors, orthophosphates, zinc compounds, silicates, and combinations thereof. These additives may be chosen from any known in the art.

Bittering agents may optionally be added to hinder accidental ingestion of the composition. Bittering agents are compositions that taste bad, so children or others are discouraged from accidental ingestion. Exemplary bittering agents include denatonium benzoate, aloin, and others. Bittering agents may be present in the composition at an amount of from about 0 to about 1 weight percent, or an amount of from about 0 to about 0.5 weight percent, or an amount of from about 0 to about 0.1 weight percent in various embodiments, based on the total weight of the composition. In various non-limiting embodiments, all values, both whole and fractional, between and including all of the above, are hereby expressly contemplated for use herein.

In various embodiments, e.g. in laundry/dishwashing embodiments, proteases, amylases, lipases, and/or combinations thereof may or may not be utilized for soil removal and to increase efficacy of multi-functional cleaning. In other embodiments, various bleach systems may or may not be utilized, e.g. peroxygen compounds (e.g., sodium percarbonate), bleach activators (TAED, NOBS), etc. In further embodiments, anti-redeposition polymers such as, but not limited to, polyacrylates and copolymers, carboxymethylcellulose (CMC), polyvinyl alcohol, etc. and similar soil-release polymers can be used to minimize film formation. In other embodiments, rinse aids/hydrotrope may or may not be utilized especially for automatic dishwashing applications, to improve drying and prevent spotting. In other embodiments, fragrances and optical brighteners may or may not be used. In still other embodiments, enzyme stabilizers, e.g. borates or polyols, may or may not be used for enzyme longevity in liquid formulations. In other embodiments, specific adjunct combinations (e.g., surfactant+builder+chelant+oligomer) may be utilized. Moreover, particular surfactants may be preferred for use, e.g. nonionic surfactants for dishwashing applications and anionic surfactants for laundry applications. In still other embodiments, phosphate-free and biodegradable additive, e.g. adjuncts such as MGDA, GLDA, APGs may be utilized for sustainability. Even further, the composition may be in compliance with one or more EU detergent regulations and/or EPA phosphate restrictions. Moreover, the composition may exhibit stability under high ionic strength and/or temperature.

In various embodiments, one or more additives is independently present in an amount of from about 0 to about 50, about 5 to about 45, about 10 to about 40, about 15 to about 35, about 20 to about 30, about 25 to about 30, or about 10, 9, 8, 7, 6, 5, 4, 3, 2, 1, 0.5, 0.1, 0.05, or 0.01, or any range thereof, weight percent actives based on a total weight of the composition. In various non-limiting embodiments, all values, both whole and fractional, between and including all of the above, are hereby expressly contemplated for use herein.

In one embodiment, the composition is free of, or includes less than 5, 4, 3, 2, 1, 0.5, or 0.1, weight percent of, a solvent other than water, e.g. an organic solvent, non-polar solvent, polar aprotic solvent, polar protic solvent, etc. and combinations thereof. In various non-limiting embodiments, all values, both whole and fractional, between and including all of the above, are hereby expressly contemplated for use herein.

In various embodiments, there may be synergistic carbonate inhibition when biodegradable chelants (MGDA, GLDA) or polycarboxylates are utilized. Moreover, it is contemplated that compatibility may be improved with non-phosphate builders.

### Method of Making the Oligomer Component

The oligomer component of this disclosure can be formed by any method. For example, the oligomer may be formed using the following preparation:

### Preparation:

Dissolve a monomer (e.g., acrylic acid) in the chosen solvent to prepare a solution. Adjust the pH if necessary with a buffer to stabilize the carboxylic groups.

De-gas the solution by purging it with nitrogen or argon to remove oxygen, which can inhibit radical polymerization.

### Initiation:

Dissolve the initiator (e.g., AIBN) in the monomer solution.

Heat the solution to the decomposition temperature of the initiator (typically 60-90° C., depending on the initiator).

### Polymerization:

Maintain the reaction temperature and stir continuously. Free radicals generated by the initiator initiate the polymerization, leading to the growth of polymer chains.

Allow the reaction to proceed until the desired degree of polymerization or conversion is achieved. This can take several hours.

### Termination:

Cool the reaction mixture to terminate the polymerization process. Residual radicals will stabilize naturally.

### Purification:

Precipitate the polymer by adding the reaction mixture to a non-solvent (e.g., acetone or methanol, depending on the solvent used).

Wash and dry the polymer to remove unreacted monomers, initiators, and by-products.

The composition itself can be formed, for example, by combining the adjunct ingredient and the oligomer in any proportions as desired by the skilled person.

### Method of Using/Inhibiting Carbonate Deposition or Formation

The composition may be used in any application or method known in the art. For example, the composition may be used in a cleaning application, laundry application, hard or soft surface cleaning application, automatic dishwasher detergent application, water treatment application, oilfield application, etc.

In various embodiments, a method includes the step of combining water and the composition to form a mixture. The water can dilute the composition to various concentrations, as determined by the skilled person depending on desired use. In various embodiments, the composition can be diluted to about 500, 450, 400, 350, 300, 250, 200, 150, 100, 75, 50, 25, or 10, ppm, or any range thereof, based on a total weight of the mixture. The weight precent of the oligomer component, after such dilution, can also be calculated therefrom. In various non-limiting embodiments, all values, both whole and fractional, between and including all of the above, are hereby expressly contemplated for use herein.

For example, the water may be described as wash water in an automatic dishwasher method/application, laundry method/application, cleaning method/application, hard or soft surface cleaning method/application, automatic dishwasher detergent application, etc. Alternatively, the water may be described as the water of a water treatment application, oilfield application, etc.

The method may include the step of applying water, the composition, and/or the mixture to one or more of a surface to be cleaned, a textile, a component of laundry, a component to be washed in an automatic dishwasher, a component of a water treatment plant or facility, a component of an oilfield operation, etc. The water and the composition may be combined before, during, or after, application of one or more of the water and the composition to any of the above. The composition and the water may be combined as discrete and complete components or one or more of the aforementioned components of the composition may be added to each other, or to the water, individually. The water and the composition may be combined in one parts or in multiple parts and in a batch or continuous fashion. The mixture may be allowed to stand on or in any of the above surfaces or items for any period of time as chosen by the skilled person.

In various embodiments, the composition may be described as having a carbonate inhibiting value of at least about 80, 85, 90, 95, or about 100, percent. The method used to determine this value is as described in the Examples below. In various non-limiting embodiments, all values, both whole and fractional, between and including all of the above, are hereby expressly contemplated for use herein.

In various embodiments, the composition exhibits a carbonate inhibition value of at least about 80, 85, 90, 95, 99, or about 100%, while the composition and/or the oligomer component is present in an amount of less than about 250, 225, 200, 175, 150, 125, 100, 75, 50, or 25, ppm based on a total weight of the aforementioned mixture of water and the composition. The method used to determine these values is as described in the Examples below. In various non-limiting embodiments, all values, both whole and fractional, between and including all of the above, are hereby expressly contemplated for use herein.

In various embodiments, the composition exhibits a percent inhibition of carbonate of at least 80, 81, 82, 83, 84, 85, 86, 87, 88, 89, 90, 91, 92, 93, 94, 95, 96, 97, 98, 99, or even about 100, %. This is determined using the method described in detail in the Examples below. In various non-limiting embodiments, all values, both whole and fractional, between and including all of the above, are hereby expressly contemplated for use herein.

In various additional embodiments, the composition exhibits a carbonate inhibition value of at least about 80, 85, 90, 93, 95, 99, or about 100%, while the composition and/or the carbonate inhibiting oligomer is present in an amount of from about 1 to about 250, about 5 to about 250, about 10 to about 250, about 15 to about 250, about 20 to about 250, about 20 to about 30, about 30 to about 250, about 30 to about 100, about 100 to about 250, or about 20 to about 100, ppm based on a total weight of the mixture of the water and the composition. The method used to determine these values is as described in the Examples below. In various non-limiting embodiments, all values, both whole and fractional, between and including all of the above, are hereby expressly contemplated for use herein.

### EXAMPLES

A series of carbonate inhibiting compositions are formed as shown below. After formation, each is evaluated to determine Carbonate Inhibition Values.

### Example 1

A carbonate inhibiting oligomer was formed and had the following composition based on total moles of (I):

| | | mol % of |
|---|---|---|
| | | based on total |
| | x | moles of (I) |
| (I) | 1 | 39.7 |
| | 2 | 6.8 |
| | 3 | 53.5 |
| | y | |
| (II) | 1 | 9.0 |
| | 2 | 8.1 |
| | 3 | 9.0 |

### Example 2

A carbonate inhibiting oligomer had the following composition based on total moles of (I):

| | | mol % of |
|---|---|---|
| | | based on total |
| | x | moles of (I) |
| (I) | 1 | 42.1 |
| | 2 | 1.1 |
| | 3 | 56.8 |
| | y | |
| (II) | 1 | 1.6 |
| | 2 | 0 |
| | 3 | 0 |

### Comparative Example 3

1,2,3,4-Butanetetracarboxylic acid has the composition listed in the table below:

| | | mol % of |
|---|---|---|
| | | based on total |
| | x | moles of (I) |
| (I) | 1 | 0 |
| | 2 | ~100 |
| | 3 | 0 |
| | y | |
| (II) | 1 | 0 |
| | 2 | 0 |
| | 3 | 0 |

### Example 4—Scale Control

The materials from Examples 1 and 2 and comparative Example 3 with adjunct ingredients sodium carbonate and sodium bicarbonate were evaluated for their ability to prevent the precipitation of calcium carbonate in typical water treatment conditions, in the modified NACE calcium carbonate inhibition test below:

### Simulated Make-Up Water Conditions:

100.00 mg/L Ca as CaCO₃ (40.0 mg/L as Ca) (one cycle of concentration)
49.20 mg/L Mg as CaCO₃ (12.0 mg/L as Mg)
2.88 mg/L Li as CaCO₃ (0.4 mg/L Li as Li)
144.80 M Alkalinity (144.0 mg/L as HCO₃)
13.40 P Alkalinity (16.0 mg/L as CO₃)

### Materials

One incubator/shaker, containing a 125 mL flask platform, with 34 flask capacity
34 Screw-cap Erlenmeyer Flasks (125 mL)
Deionized Water
Analytical balance
Electronic pipette(s) capable of dispensing between 0.0 mL and 2.5 mL
250 Cycle Hardness Solution*
10,000 mg/L treatment solutions, prepared using known active solids of the desired treatment*
10% and 50% solutions of NaOH
250 Cycle Alkalinity Solution*
0.2 μm syringe filters or 0.2 μm filter membranes
34 Volumetric Flasks (100 mL)
Concentrated Nitric Acid
*See solution preparations in next section.

### Solution Preparations:

All chemicals used were reagent grade and weighed on an analytical balance to ±0.0005 g of the indicated value. All solutions were made within thirty days of testing. The hardness and alkalinity solutions were prepared in a one liter volumetric flask using DI water.

The following amounts of chemical were used to prepare these solutions—

### 250 Cycle Hardness Solution:

10,000 mg/L Ca⇒36.6838 g CaCl₂·2H₂O
3,000 mg/L Mg⇒25.0836 g MgCl₂·6H₂O
100 mg/L Li⇒0.6127 g LiCl

### 250 Cycle Alkalinity Solution:

36,000 mg/L HCO₃⇒48.9863 g NaHCO₃
4,000 mg/L CO₃⇒7.0659 g Na₂CO₃
   10,000 my/L Treatment Solutions:

Using percentage of active product in the supplied treatment, 250 mL of a 10,000 mg/L active treatment solution was made up for every treatment tested. The pH of the solutions was adjusted to between 8.70 and 8.90 using 50% and 10% NaOH solutions by adding the weighed polymer into a specimen cup or beaker and filling with DI water to approximately 90 mL. The pH of this solution was then adjusted to approximately 8.70 by first adding the 50% NaOH solution until the pH reached 8.00, and then by using the 10% NaOH until the pH equaled 8.70. The solution was then poured into a 250 mL volumetric flask. The specimen cup or beaker was rinsed with DI water and this water was added to the flask until the final 250 mL was reached. The amount of treatment product to be weighed was calculated as follows:

$$Grams of treatment needed = \frac{( 10 , 000 mg / L ) ( 0.25 L )}{( decimal \% of active treatment ) ( 1000 mg )}$$

### Test Setup Procedure:

The incubator shaker was turned on and set for a temperature of 50° C. to preheat. 34 screw cap flasks were set out in groups of three to allow for triplicate testing of each treatment, allowing for testing of eleven different treatments. The one remaining flask was used as an untreated blank.

96.6 grams of DI water was weighed into each flask.

Using a 2.5 mL electric pipette, 1.20 mL of hardness solution was added to each flask to simulate 3 cycles of make-up water.

Using a 250 μL electronic pipette, 200 μL of desired treatment solution were added to each flask to achieve a 20 ppm active treatment dosage. For 30, 100 and 250 ppm, 300, 1000 and 2500 μL of desired treatment solution respectively was added. A new tip on the electric pipette was used for each treatment solution so cross contamination did not occur.

Using a 2.5 mL electric pipette, 1.20 mL of alkalinity solution (3 cycles of concentration) was added to each flask to simulate 3 cycles of make-up water. The addition of alkalinity was done while swirling the flask, so as not to generate premature scale formation from high alkalinity concentration pooling at the addition site.

One “blank” solution was prepared in the exact same manner as the above treated solutions, except DI water was added in place of the treatment solution.

All 34 flasks uncapped were placed onto the shaker platform and the door closed. The shaker was run at 250 rpm and 50° C. for 17 hours.

A “total” solution was prepared in the exact same manner as the above treated solutions were prepared, except that DI water was used in place of both the treatment solution and alkalinity solution. This solution was capped and left overnight outside the shaker.

### Test Analysis Procedure:

Once 17 hours had passed, the 34 flasks were removed from the shaker and allowed to cool for one hour. Each flask solution was filtered through a 0.2 μm filter membrane. 250 μl of nitric acid was added to 10 ml of each filtrate, and each filtrate was analyzed directly for lithium, calcium, and magnesium concentrations by an Inductively Couple Plasma (ICP) Optical Emission System. The “total” solution was analyzed in the same manner.

### Calculations of Results:

Once the lithium, calcium, and magnesium concentrations were known in all 34 shaker samples and in the “total” solution, the percent inhibition was calculated for each treatment. The lithium was used as a tracer of evaporation in each flask (typically about ten percent of the original volume). The lithium concentration found in the “total” solution was assumed to be the starting concentration in all 34 flasks. The concentrations of lithium in the 34 shaker samples were each divided by the lithium concentration found in the “total” sample. These results provided the multiplying factor for increases in concentration, due to evaporation. The calcium and magnesium concentrations found in the “total” solution were also assumed to be the starting concentrations in all 34 flasks. By multiplying these concentrations by each calculated evaporation factor for each shaker sample, the final intended calcium and magnesium concentration for each shaker sample was determined. By subtracting the calcium and magnesium concentrations of the “blank” from both the actual and intended concentrations of calcium and magnesium, then dividing the resulting actual concentration by the resulting intended concentration and multiplying by 100, the percent inhibition for each treated sample was calculated. The triplicate treatments were averaged to provide more accurate results.

| | % | % | % | % |
|---|---|---|---|---|
| | carbonate | carbonate | carbonate | carbonate |
| | inhibition | inhibition | inhibition | inhibition |
| Example | at 20 ppm | at 30 ppm | at 100 ppm | at 250 ppm |
| Example 1 | 33 | 85 | | |
| Example 2 | 80 | 93 | | |
| Example 3 | | | 6 | 1 |
| (comparative) | | | | |

In the test above, anything above 80% inhibition is considered acceptable. These data in Table indicate that the carbonate inhibition performance of Example 1 and 2 are good but that of the comparative Example 3 is not good even at significantly higher levels. Surprisingly in Example 3 where x=2 there is poor carbonate inhibition but in Example 1 and 2 where x=2 is low and x=1 and 3 are the main fractions the carbonate inhibition is excellent. One skilled in the art would not have predicted this.

### Example 5—Laundry

The materials from Examples 1 and 2 and commercial polymers were evaluated for their ability to prevent the precipitation of calcium carbonate (anti-encrustation) in typical laundry applications. The anti-encrustation was adapted from the ACI method. The water hardness was 22 dH°, the test had additional clay soil and was run for 10 cycles. The % ash for materials from Examples 1 and 2 and commercial polymers are listed the Table below:

| | Wt % of active material in | |
|---|---|---|
| Material | the formulation | % ash |
| None | — | 3.09 |
| Example 1 | 1.0 | 0.52 |
| Example 2 | 1.0 | 0.31 |
| Sokolan CP 5 (BASF) | 1.0 | 1.63 |
| Acusol 445N (Dow) | 1.0 | 0.91 |

The % ash is a direct measure of the amount of Calcium carbonate deposited on the fabric during the wash cycles of the test with the lower number indicating better performance. These data clearly that the anti-encrustation performance of the materials of this invention are superior to that of commercially available polymers. In fact, to the skilled person, the aforementioned numbers are truly exceptional and unexpected.

### Example 6—Automatic Dishwash

The materials from Examples 1 and 2 and commercial polymers were evaluated for their ability to prevent the precipitation of calcium carbonate (Filming and spotting) in typical automatic dishwash applications. The powder formulation used was:

| Product | Function | Amount (%) |
|---|---|---|
| Dissolvine MX | MGDA as a chelating agent | 25 |
| Na-carbonate | Builder | 25 |
| Material | Example 1 or 2 | 5 |
| Na4HEDP | Sequestrant, transition metals | 1.5 |
| | binder | |
| Ceteareth-25 or Ethylan | Surfactant, cleaning, rinsing | 5 |
| CPG7545 | | |
| Na-percarbonate | Oxidizing agent, bleach | 15 |
| TAED | Bleach activator | 2 |
| Protease | Enzyme, cleaning | 2.5 |
| Amylase | Enzyme, cleaning | 1.0 |
| Zn-sulfate | Glass corrosion inhibitor | 0.2 |
| Na-disilicate | Buffering agent, pH control | 5 |
| Na-sulfate | Bulking agent | Up to 100% |

The test conditions were:
375 ppm (21 dGH) hardness
Run time—1 h 35 min
Washing, 2 rinses, drying
18 g powder/cycle
25 g ballast soil
135° F. (57° C.)
pH 10.5-10.7

The ballast soil was:

| Ingredients | Amount (g) |
|---|---|
| DI water | 11.54 |
| Milk | 2.61 |
| Egg yolk powder | 1.50 |
| Gravy powder | 1.25 |
| Potato starch | 0.26 |
| Margarine | 5.22 |
| Mustard | 1.31 |
| Tomato Ketchup | 1.31 |

The test was Conducted for 20 cycles and the glasses were evaluated fulfilling on and spotting on a scale of 1-10 with 1 being the worst and 10 being excellent.

| Material | Filming | Spotting |
|---|---|---|
| None | 4.0 | 4.0 |
| Example 1 | 6.0 | 6.5 |
| Example 2 | 5.5 | 6.5 |

The results of this test indicate that the materials of this invention are good for minimizing filming and spotting in dishwasher applications.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A composition comprising:
an adjunct ingredient chosen from a surfactant, a builder, a corrosion inhibitor, a chelating agent, and combinations thereof; and
a carbonate inhibiting oligomer component comprising a compound (I) having the structure: 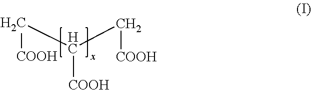
wherein x is independently about 1 and/or 3.

2. The composition of claim 1 wherein the oligomer component further comprises compound (II) having the structure: 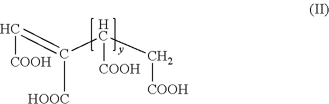
wherein y is independently about 1 and/or 3.

3. The composition of claim 1 wherein the oligomer component comprises less than 25 mole percent of a compound (I) and/or a compound (II) wherein x is about 2 and/or y is about 2, respectively, based on a total weight of compound (I).

4. The composition of claim 1 wherein the oligomer component comprises a first compound (I) wherein x is about 1 and a second compound (I) wherein x is about 3.

5. The composition of claim 1 wherein the oligomer component comprises a first compound (II) wherein y is about 1 and a second compound (II) wherein y is about 3.

6. The composition of claim 1 wherein the oligomer component comprises:
about 10 to about 90 mole percent of compound (I) wherein x is about 1;
about 10 to about 90 mole percent of compound (I) wherein x is about 3.

7. The composition of claim 1 wherein the oligomer component comprises:
about 5 to about 25 mole percent of a first compound (II) wherein y is about 1; and
about 5 to about 25 mole percent of a second compound (II) wherein y is about 3.

8. The composition of claim 1 wherein the oligomer component comprises:
about 35 to about 45 mole percent of compound (I) wherein x is about 1;
about 1 to about 10 mole percent of compound (I) wherein x is about 2;
about 50 to about 60 mole percent of compound (I) wherein x is about 3;
about 1 to about 10 mole percent of compound (II) wherein y is about 1;
about 0 to about 10 mole percent of compound (II) wherein y is about 2; and
about 1 to about 10 mole percent of compound (II) wherein y is about 3.

9. The composition of claim 1 wherein the oligomer component consists essentially of compound (I).

10. The composition of claim 1 wherein the oligomer component is present in an amount of from about 0.1 to about 50 weight percent actives based on a total weight of the composition.

11. The composition of claim 1 wherein the oligomer component is present in an amount of from about 0.25 to about 25 weight percent actives based on a total weight of the composition.

12. The composition of claim 1 wherein the oligomer component is present in an amount of from about 0.5 to about 5 weight percent actives based on a total weight of the composition.

13. The composition of claim 1 wherein the oligomer component is present in an amount of from about 1 to about 3 weight percent actives based on a total weight of the composition.

14. The composition of claim 1 that is a non-phosphate formulation.

15. The composition of claim 1 wherein the surfactant is present and is chosen from dodecylbenzene sulfonic acid, an alkoxylated alcohol, and combinations thereof.

16. The composition of claim 1 wherein the builder is present and is sodium carbonate.

17. The composition of claim 1 wherein the chelating agent is present and is chosen from glutamic acid N,N-diacetic acid, methylglycinediacetic acid, and combinations thereof.

18. The composition of claim 1 further comprising an enzyme chosen from proteases, amylases, lipases, and combinations thereof.

19. The composition of claim 1 wherein the oligomer component comprises:
about 35 to about 40 mole percent of compound (I) wherein x is about 1;
about 6 to about 8 mole percent of compound (I) wherein x is about 2;
about 50 to about 55 mole percent of compound (I) wherein x is about 3;
about 6 to about 12 mole percent of compound (II) wherein y is about 1;
about 6 to about 12 mole percent of compound (II) wherein y is about 2; and
about 6 to about 12 mole percent of compound (II) wherein y is about 3.

20. A mixture comprising water and the composition of claim 1 wherein the composition exhibits a carbonate inhibition value of at least 80% while the carbonate inhibiting oligomer is present in an amount of less than about 250 ppm based on a total weight of the mixture.
